(19) United States
(12) Patent Application Publication
(10) Pub. No.: US 2022/0007617 A1
(43) Pub. Date: Jan. 13, 2022

(54) DOG POCKET

(71) Applicant: Melinda M. Lopez, Whistler (CA)

(72) Inventor: Melinda M. Lopez, Whistler (CA)

(73) Assignee: Melinda M. Lopez, Whistler (CA)

(21) Appl. No.: 16/927,572

(22) Filed: Jul. 13, 2020

(51) Int. Cl. A01K 27/00

(52) U.S. Cl. CPC A01K 27/008; A01K 27/001; A01K 27/002

(57) ABSTRACT

A dog pocket adapted to attach to a collar or harness of a pet dog is disclosed. The dog pocket includes a first portion and a second portion attached to the first portion and defines a pocket therebetween to receive one or more articles, specifically to receive plastic bags containing the pet's excrement for storage during a walk. Further, the dog pocket includes a first strip and a second strip. The first strip is disposed proximate to a first longitudinal edge of the second portion and adapted to loop around the collar or harness to facilitate a removable attachment of the dog pocket with the collar or harness. The second strip is disposed proximate to a second longitudinal edge of the second portion and adapted to loop around the collar or harness to facilitate a removable attachment of the dog pocket with the collar or harness.

### TECHNICAL FIELD

The present disclosure relates, generally, to a dog pocket. More particularly, the present disclosure pertains to a dog pocket having a collapsible pocket that attaches to a dog's collar or harness for the purpose of carrying a plastic dog excrement collection bag containing the dog's excrement, for convenient storage during a walk.

### BACKGROUND

A dog frequently requires a walk to keep it socially active and maintain its physical activeness. The pets are also trained to relieve their excreta during the walk to keep home and interiors clean. It is a responsibility of pet owners to pick up their pet's feces in order to keep the public areas clean and comply with the social regulations. To comply with this, the pet owners carry their own plastic collection bags to carry the feces of the pets during the walk. In many outdoor recreation areas, a dog owner may have to walk more than a kilometer before reaching a designated bin to dispose of the plastic bag containing the dog feces. Also, the pet owners have to carry their personal belongings like phone, mp3, keys and any other belongings required during the walk. It becomes difficult for the pet owner to simultaneously secure their belongings and manage the pet and also manage the plastic bag containing the dog's feces. People dislike carrying the plastic bags containing the pet's feces due to inconvenience and stigma, and pet owners will often leave these bags on the side of the trail or in the forest, adversely affecting the cleanliness of the surroundings.

### SUMMARY

According to an aspect of the disclosure a dog pocket adapted to attach to a collar or harness of a pet is disclosed. The dog pocket includes a first portion and a second portion attached to the first portion and defines a pocket therebetween to receive one or more articles. Further, the dog pocket includes a first strip and a second strip. The first strip is disposed proximate to a first longitudinal edge of the second portion and adapted to loop around the collar or harness to facilitate a removable attachment of the dog pocket to the collar or harness. The second strip is disposed proximate to a second longitudinal edge of the second portion and adapted to loop around the collar or harness to facilitate a removable attachment of the dog pocket to the collar or harness of the pet.

In an embodiment, the dog pocket further includes a first hook and a fastener assembly having a first hook member attached to the first strip and a first loop member attached to the second portion and adapted to engage with the first hook member to facilitate the attachment of the dog pocket to the collar or harness of the pet.

In an embodiment, the dog pocket further includes a second hook and a fastener assembly having a second hook member attached to the second strip and a second loop member attached to the second portion and adapted to engage with the second hook member to facilitate the attachment of the dog pocket to the collar or harness of the pet.

In an embodiment, the dog pocket further includes a pair of clips to facilitate a secure attachment of the dog pocket with the collar or harness of the pet.

In an embodiment, the dog pocket includes a waterproof and washable material.

According to another aspect of a disclosure a dog pocket adapted to attach to a collar or harness of a pet is disclosed. The dog pocket includes a first portion and a second portion attached to the first portion and defining a pocket therebetween to receive one or more articles. Further, the dog pocket includes a first strip and a second strip. The first strip is disposed proximate to a first longitudinal edge of the second portion and adapted to loop around the collar or harness to facilitate a removable attachment of the dog pocket with the collar or harness. The second strip is disposed proximate to a second longitudinal edge of the second portion and adapted to loop around the collar or harness to facilitate a removable attachment of the dog pocket with the collar or harness. Furthermore, the dog pocket includes a pair of clips to facilitate a secure attachment of the dog pocket with the collar or harness of the pet.

In an embodiment, the dog pocket further includes a first hook and fastener assembly having a first hook member attached to the first strip and a first loop member attached to the second portion and adapted to engage with the first hook member to facilitate the attachment of the dog pocket to the collar or harness of the pet.

In an embodiment, the dog pocket further includes a second hook and fastener assembly having a second hook member attached to the second strip and a second loop member attached to the second portion and adapted to engage with the second hook member to facilitate the attachment of the dog pocket to the collar or harness of the pet.

In an embodiment, the dog pocket includes a waterproof material.

For a more complete understanding of the present invention, reference is made to the following detailed description and accompanying drawings. In the drawing, like reference characters refer to like parts throughout the views in which.

### BRIEF DESCRIPTION OF THE DRAWINGS

FIG. 1 illustrates a perspective view of a pet, for example, a dog, with a dog pocket coupled to the neck collar or harness of the pet, in accordance with an embodiment of the disclosure;

FIG. 2 illustrates a front view of the dog pocket with a pair of clips attached, in accordance with an embodiment of the disclosure; and

FIG. 3 illustrates a rear view of the dog pocket with the pair of clips attached, in accordance with an embodiment of the disclosure.

### DETAILED DESCRIPTION

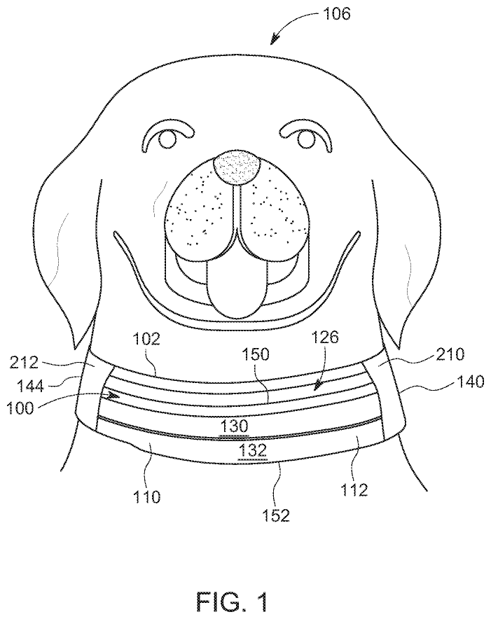

Referring to FIG. 1 a dog pocket 100 attached to a collar or harness 102 of a pet 106 is shown. Typically, the collar or harness 102 is coupled to a neck or a back of the pet 106 and facilitates in holding/controlling a body of the pet 106. The collar or harness 102 is further connected to a strap (not shown) configured to be held by the pet owner. The strap facilitates in pulling or maneuvering the body of the pet 106 as desired by the pet owner.

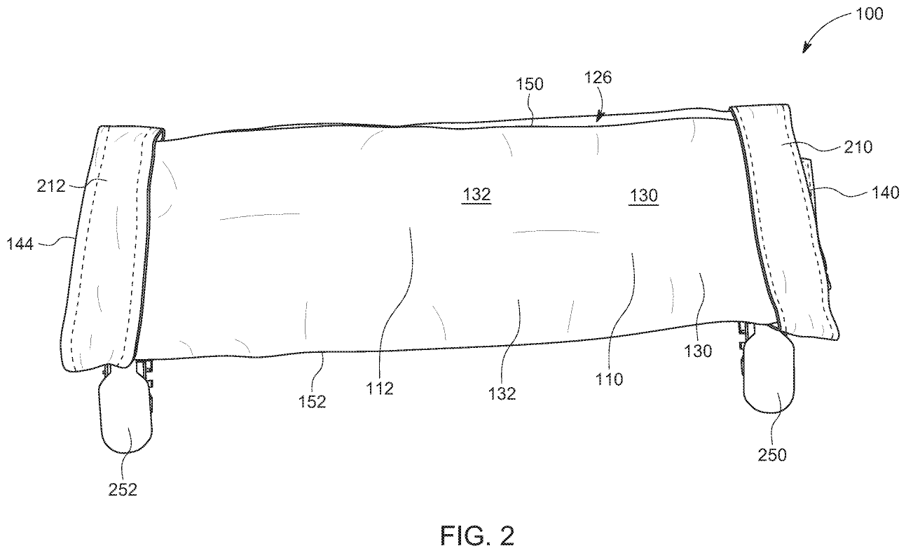

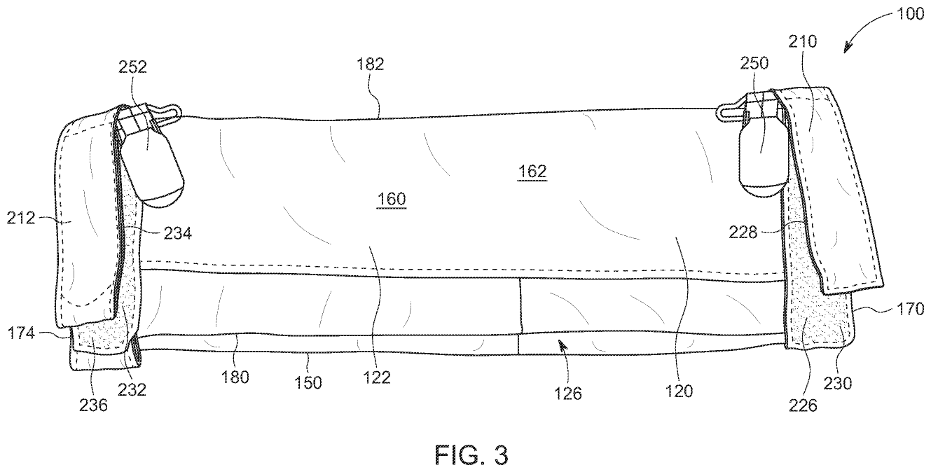

Referring to FIG. 2 and FIG. 3, the dog pocket 100 detached from the collar or harness 102 of the pet 106 is shown. As shown, the dog pocket 100 includes a first portion 110 (front portion 110), best shown in FIG. 2, defining a first layer 112 and a second portion 120 (rear portion 112), best shown in FIG. 3, defining a second layer 122 of the dog pocket 100. The second portion 120 is attached to the first portion 110 such that the first portion 110 and the second portion 120 together define a pocket 126 therebetween. In addition, as shown in FIG. 2, the first portion 110 includes a first surface 130 defining a front surface 132 of the dog pocket 100 and a second surface (not shown) defining an inside surface of the pocket 126. Additionally, the first portion 110 includes a first longitudinal edge 140 and a second longitudinal edge 144 disposed opposite to the first longitudinal edge 140. In addition, the first portion 110 includes a first lateral edge 150 extending from the first longitudinal edge 140 and the second longitudinal edge 144 and a second lateral edge 152 disposed opposite to the first lateral edge 150 and extending from the first longitudinal edge 140 to the second longitudinal edge 144.

Referring to FIG. 3, the second portion 120 includes a first surface 160 defining a rear surface 162 of the second portion 120 and a second surface (not shown) defining an inner surface of the pocket 126. Additionally, the second portion 120 includes a first longitudinal edge 170 and a second longitudinal edge 174 arranged opposite to the first longitudinal edge 170. In addition, the second portion 120 includes a first lateral edge 180 extending from the first longitudinal edge 170 to the second longitudinal edge 174 and a second lateral edge 182 disposed opposite to the first lateral edge 180 and extending between the first longitudinal edge 170 and the second longitudinal edge 174. As an example, the first portion 110 and the second portion 120 is made using polytetrafluoroethylene material to facilitate a waterproof arrangement.

In an embodiment, to facilitate the formation of the pocket 126, the first portion 110 and the second portion 120 are attached together. For so doing, the first longitudinal edge 140 of the first portion 110 is attached with the first longitudinal edge 170 of the second portion 120, and the second longitudinal edge 144 of the first portion 110 is attached to the second longitudinal edge 174 of the second portion 120. Further, the second lateral edge 152 of the first portion 110 is attached to the second lateral edge 182 of the second portion 120, while the first lateral edge 150 of the first portion 110 and the first lateral edge 180 of the second portion 120 remain disengaged from each other defining an opening of the pocket 126. The first portion 110 and the second portion 120 may be attached to each other by using an adhesive or by sewing or by using any other suitable method. In an embodiment, the dog pocket 100 may include a zip (not shown) to open and close the opening. In addition, the first portion 110 may include a flap to cover the opening of the pocket 126. In an embodiment, the flaps are made up of an expanded polytetrafluoroethylene material to facilitate a waterproof arrangement between the zip and the flap.

Further the dog pocket 100 includes a pair of strips, for example, a first strip 210 and a second strip 212, extending from the second portion 120 and adapted to couple with the collar or harness 102 of the pet 106. Each of the pair of strips 210, 212 is adapted to encircle around the collar or harness 102 and adapted to couple with the second portion 120 of the dog pocket 100. The first strip 210 is disposed proximate to the first longitudinal edge 170 and extends along the first longitudinal edge 170, while the second strip 212 is disposed proximate to the second longitudinal edge 174 and extends along the second longitudinal edge 174. In an embodiment, the dog pocket 100 may include a first hook and loop fastener assembly 226 having a first hook member 228 attached to the first strip 210 and a first loop member 230 attached to the second portion 120. The first hook member 228 may include a plurality of hooks, while the first loop member 230 may include a plurality of loops adapted to engage with the plurality of hooks to engage the first strip 210 with the second portion 120, thereby facilitating the attachment/engagement of the dog pocket 100 to the pet. In an embodiment, the dog pocket 100 may include a second hook and loop fastener assembly 232 having a second hook member 234 attached to the second strip 212 and a second loop member 236 attached to the second portion 120. The second hook member 234 may include a plurality of hooks, while the second loop member 236 may include a plurality of loops adapted to engage with the plurality of hooks to engage the second strip 212 with the second portion 120, thereby facilitating the attachment/engagement of the dog pocket 100 to the collar or harness 102 of the pet 106.

In an embodiment, the dog pocket 100 includes a pair of clips to facilitate the attachment of the dog pocket 100 with the collar or harness 102 of the pet 106. As an example, the pair of clips includes a first clip 250 disposed proximate to the first longitudinal edge 170 of the second portion 120 and a second clip 252 disposed proximate at the second longitudinal edge 174 of the second portion 120. The clips 250 252 prevents disengagement of the dog pocket 100 from the collar or harness 102 when the strips 210, 212 are disengaged from the second portion 120.

The working of the dog pocket 100 is now explained. While taking the pet 106, the dog pocket 100 may be attached to the collar or harness 102 of the pet 106. The dog pocket 100 may be attached to the collar or harness 102 by encircling the strips 210, 212 around the collar or harness 102 and then attaching the strips 210, 212 to the second portion 120 using the hook and loop fastener assemblies 226, 232. In this position, the pocket 126 remains in a collapsed position. Further, the clips 250, 252 are also engaged with the collar or harness 102 to prevent any disengagement of the dog pocket 100 from the pet 106. During the walk the pet 106 generally have a habit of defecating. This habit helps in maintaining the cleanliness of interiors like home, garage and balconies of the pet owner. For so doing, the pet owner may pick up the pet feces, and put the pet feces inside the pocket 126 of the dog pocket 100. In this manner, the feces of the pet 106 may be disposed in a garbage bin or in any another disposal means instead of lying in the surroundings. For reusing the dog pocket 100, the dog pocket 100 may be washed with clean water or soap and becomes ready for use.

The advantages of the dog pocket 100 are now explained. The dog pocket 100 is easy to carry and may be easily attached and detached to the collar or harness/strap/collar/leash 102 of the pet 106. The dog pocket 100 may be attached to both the collar or harness 102 like the neck collar or harness and the back collar or harness of the pet 106 as it suits to the pet 106. The dog pocket 100 is washable when removed from the collar or harness 102 that facilitates in maintaining the hygiene of the dog pocket 100. In addition, the dog pocket 100 is waterproof that further restricts the smell of the feces within the dog pocket 100. Also, the dog pocket 100 may be used multiple times during a walk thereby preventing any requirement of plastic bags to dispose the feces thereby promoting the cleanness and green environment.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

### LIST OF ELEMENTS

100 dog pocket
102 collar or harness/collar
106 pet
110 first portion
112 first layer
120 second portion
122 second layer
126 pocket
130 first surface
132 front surface
140 first longitudinal edge
144 second longitudinal edge
150 first lateral edge
152 second lateral edge
160 first surface
162 rear surface
170 first longitudinal edge
174 second longitudinal edge
180 first lateral edge
182 second lateral side
210 first strip
212 second strip
226 first hook and loop fastener assembly
228 first hook member
230 first loop member
232 second hook and loop fastener assembly
234 second hook member
236 second loop member
250 first clip
252 second clip

What is claimed is:

1. A dog pocket adapted to attach to a collar or harness of a pet, the dog pocket comprising:
a first portion;
a second portion attached to the first portion and defining a pocket therebetween to receive one or more articles;
a first strip disposed proximate to a first longitudinal edge of the second portion and adapted to loop around the collar or harness to facilitate a removable attachment of the dog pocket with the collar or harness; and
a second strip disposed proximate to a second longitudinal edge of the second portion and adapted to loop around the collar or harness to facilitate a removable attachment of the dog pocket with the collar or harness of the pet.

2. The dog pocket of claim 1 further including a first hook and a fastener assembly having a first hook member attached to the first strip and a first loop member attached to the second portion and adapted to engage with the first hook member to facilitate the attachment of the dog pocket to the collar or harness of the pet.

3. The dog pocket of claim 1 further including a second hook and a fastener assembly having a second hook member attached to the second strip and a second loop member attached to the second portion and adapted to engage with the second hook member to facilitate the attachment of the dog pocket to the collar or harness the pet.

4. The dog pocket of claim 1 further including a pair of clips to facilitate a secure attachment of the dog pocket with the collar or harness of the pet.

5. The dog pocket of claim 1, wherein the dog pocket includes a waterproof material.

6. A dog pocket adapted to attach to a collar or harness of a pet, the dog pocket comprising:
a first portion;
a second portion attached to the first portion and defining a pocket therebetween to receive one or more articles;
a first strip disposed proximate to a first longitudinal edge of the second portion and adapted to loop around the collar or harness to facilitate a removable attachment of the dog pocket with the collar or harness;
a second strip disposed proximate to a second longitudinal edge of the second portion and adapted to loop around the collar or harness to facilitate a removable attachment of the dog pocket with the collar or harness; and
a pair of clips to facilitate a secure attachment of the dog pocket with the collar or harness of the pet.

7. The dog pocket of claim 6 further including a first hook and fastener assembly having a first hook member attached to the first strip and a first loop member attached to the second portion and adapted to engage with the first hook member to facilitate the attachment of the dog pocket to the collar or harness of the pet.

8. The dog pocket of claim 6 further including a second hook and fastener assembly having a second hook member attached to the second strip and a second loop member attached to the second portion and adapted to engage with the second hook member to facilitate the attachment of the dog pocket to the collar or harness of the pet.

9. The dog pocket of claim 6, wherein the dog pocket includes a waterproof material.
